(19) United States
(12) Patent Application Publication
(10) Pub. No.: US 2005/0028148 A1
(43) Pub. Date: Feb. 3, 2005

(54) Method for dynamic recompilation of a program

(75) Inventor: Jan Civlin, Sunnyvale, CA (US)

Correspondence Address: MARTINE & PENILLA, LLP, 710 LAKEWAY DRIVE, SUITE 170, SUNNYVALE, CA, 94085, US

(73) Assignee: SUN MICROSYSTEMS, INC., SANTA CLARA, CA (US)

(21) Appl. No.: 10/633,108

(22) Filed: Aug. 1, 2003

(51) Int. Cl. G06F 9/45

(52) U.S. Cl. 717/145; 717/153

(57) ABSTRACT

In a method for dynamic recompilation of a program, binary code for a program is identified, a portion of the binary code is obtained, and the obtained portion of the binary code is executed while being optimized for, e.g., use with a new hardware architecture. During execution, dynamic changes in flow are identified to enable additional portions of the binary code to be obtained and executed. The executed and optimized portion of the binary code and any additional portions of the binary code are saved to an optimized binary code file for the program. The obtaining and executing of portions of the binary code is continued until all portions of the binary code have been saved to the optimized binary code file for the program. Thereafter, when the program is called, the optimized binary code file for the program can be executed.

### BACKGROUND OF THE INVENTION

The present invention relates generally to computer systems and, more particularly, to a method for dynamic recompilation of a program.

As is well known to those skilled in the art, computer programs are compiled into binary (machine) code for execution by a processor. As shown in FIG. 1, original source code 10 is passed through compiler 12 to obtain original binary code 14. This compilation process is typically carried out with a specific existing hardware architecture in mind. Consequently, when a new hardware architecture executes an old program that was not compiled for this architecture, the benefits of the new hardware architecture may not be realized.

The ideal solution to this problem would be to recompile the old program. For this approach to be effective, the original source code is required. Unfortunately, it is often the case that the original source code is not available. In cases where the original source code is not available, static optimization techniques, which are implemented at the time of compiling, have been used to modify the original binary code for use with a new hardware architecture. The results obtained have been unsatisfactory, however, because portions of the code inevitably are lost.

In view of the foregoing, there is a need for a method of recompiling a program to optimize the program for use with a new hardware architecture.

### SUMMARY OF THE INVENTION

Broadly speaking, the present invention fills this need by providing a method for dynamic recompilation of a program by means of code execution. Computer readable media containing program instructions for dynamic recompilation of a program also are provided.

In accordance with one aspect of the present invention, a method for dynamic recompilation of a program is provided. In this method, binary code for a program is identified, a portion of the binary code is obtained, and the obtained portion of the binary code is executed while being optimized. During execution, dynamic changes in flow are identified to enable additional portions of the binary code to be obtained and executed. The executed and optimized portion of the binary code and any additional portions of the binary code are saved to an optimized binary code file for the program.

In one embodiment, the obtaining and executing of portions of the binary code is continued until all portions of the binary code have been saved to the optimized binary code file for the program. In one embodiment, during each execution of the optimized binary code file for the program, the optimized binary code file is maintained by detecting a missing additional portion associated with a dynamic change in flow detected during execution of a portion of the optimized binary code file. The missing additional portion is obtained from the binary code for the program and is then executed. The executed missing additional portion is saved to the optimized binary code file for the program for use in future executions.

In one embodiment, the dynamic changes in flow include a jump instruction. In one embodiment, the optimizing is configured to optimize the portion of the binary code for a new hardware architecture.

In accordance with another aspect of the present invention, computer readable media containing program instructions for dynamic recompilation of a program are provided. In one embodiment, the computer readable media have a) program instructions for identifying binary code for a program, b) program instructions for obtaining a portion of the binary code, c) program instructions for executing the portion of the binary code while optimizing the portion of the binary code, the executing identifying dynamic changes in flow to enable additional portions of the binary code to be obtained and executed, d) program instructions for saving the executed and optimized portion of the binary code and any additional portions of the binary code to an optimized binary code file for the program; and e) program instructions for repeating program instructions b), c), and d) until all portions of the binary code have been saved to the optimized binary code file for the program.

In one embodiment, the computer readable media further have program instructions for executing the optimized binary code file for the program, program instructions for detecting a missing additional portion associated with a dynamic change in flow detected during execution of a portion of the optimized binary code file for the program, program instructions for obtaining the missing additional portion from the binary code for the program, program instructions for executing the missing additional portion; and program instructions for saving the executed missing additional portion to the optimized binary code file for the program.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a schematic diagram that illustrates the compilation of original source code into original binary code in accordance with conventional practice.

FIG. 2 is a schematic diagram that illustrates the use of a dynamic optimizer (DO) to recompile a program for use with a new hardware architecture in accordance with one embodiment of the invention.

FIG. 3 is a schematic diagram that illustrates the manner in which the DO uses the binary code for the program to create the optimized binary code for the program in accordance with one embodiment of the invention.

FIG. 4 is a flow chart diagram illustrating the method operations performed in the dynamic recompilation of a program in accordance with one embodiment of the present invention.

FIG. 5 is a flow chart diagram illustrating the method operations performed in maintaining an optimized binary code file for a program in accordance with one embodiment of the present invention.

### DETAILED DESCRIPTION OF EXEMPLARY EMBODIMENTS

Several exemplary embodiments of the invention will now be described in detail with reference to the accompanying drawings. FIG. 1 is discussed above in the “Background of the Invention” section.

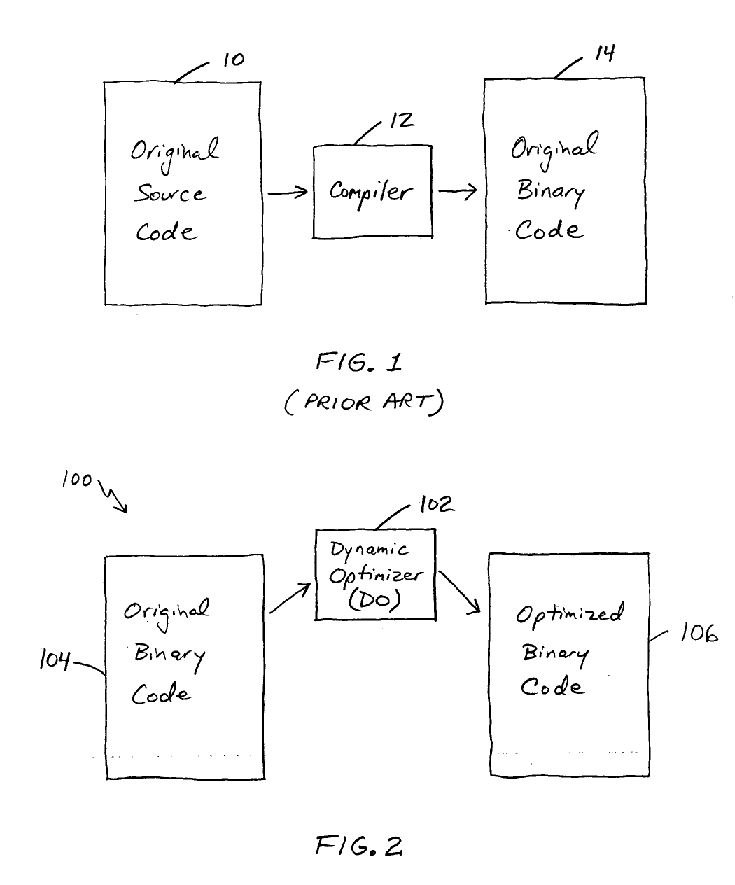

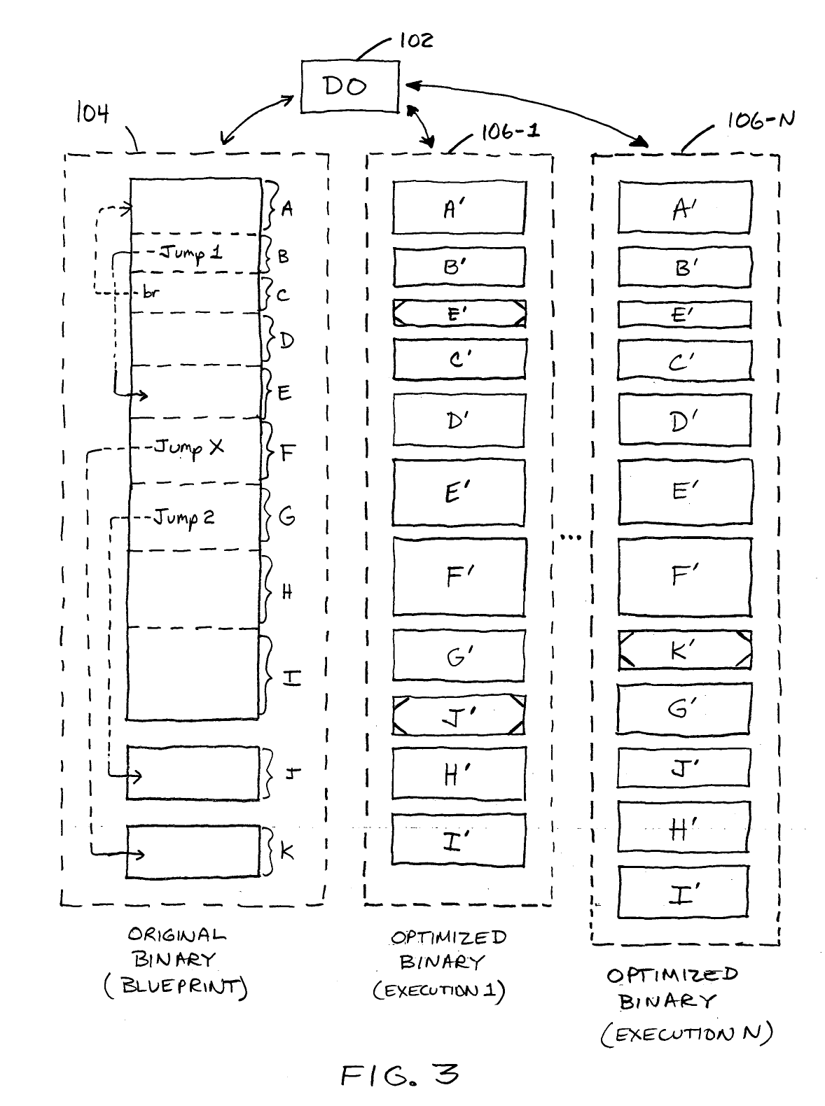

FIG. 2 is a schematic diagram 100 that illustrates the use of a dynamic optimizer (DO), which may be implemented in the form of software, to recompile a program for use with a new hardware architecture in accordance with one embodiment of the invention. Referring to FIG. 2, dynamic optimizer (DO) 102 uses original binary code 104 (hereafter “binary code 104”) for a program to create optimized binary code 106 for the program. DO 102 does not make any changes to binary code 104 for the program, but instead uses the binary code as a “blueprint” for the creation of optimized binary code 106 for the program. Additional details regarding the functionality of DO 102 are set forth below with reference to FIGS. 3-5.

FIG. 3 is a schematic diagram 150 that illustrates the manner in which the DO uses the binary code for the program to create the optimized binary code for the program in accordance with one embodiment of the invention. Referring to FIG. 3, DO 102 obtains binary code 104 in portions, e.g., basic blocks, which are designated in FIG. 3 by the letters A-I. Thus, DO 102 first obtains portion A of binary code 104. DO 102 then executes portion A of binary code 104 and, in the course of such execution, optimizes portion A of the binary code. By way of example, the optimization of the binary code may be configured to modify this code for optimal performance when executed using a new hardware architecture, i.e., a hardware architecture different from that for which the program was originally compiled. Those skilled in the art are capable of formulating suitable optimization routines for optimizing the binary code for specific hardware architectures.

During execution of a portion of the binary code, program instructions that take the flow outside the portion of the binary code being executed may be encountered. These changes in flow may be either static or dynamic. Static changes in flow, e.g., a branch instruction (e.g., br offset 16), do not present a problem because the destination address is fixed and known. On the other hand, dynamic changes in flow, e.g., a jump instruction (e.g., jump to value reg 3), require special handling to avoid losing portions of the binary code. When a dynamic change in flow is identified, DO 102 obtains the additional portions of the binary code associated with the dynamic change in flow and executes these additional portions of the binary code. By way of example, as shown in FIG. 3, portion B of binary code 104 includes a dynamic change in flow, i.e., jump 1, which takes the flow to portion E of the binary code. When this dynamic change in flow is identified during execution and optimization of portion B of binary code 104, DO 102 obtains and executes portion E of the binary code as part of the execution and optimization of portion B of the binary code.

Once a portion of the binary code has been executed and optimized, DO 102 saves this portion of the binary code in an optimized binary code file for the program. As shown in FIG. 3, optimized binary code 106-1 represents the optimized binary code file saved after the first execution of the program and optimized binary code 106-N represents the optimized binary code file saved after the Nth execution of the program. During the first execution of the program, DO 102 executed and optimized portions A-I of binary code 104. Portion A was first executed and optimized, and then saved as A′ in optimized binary code 106-1. During the execution and optimization of portion B, DO 102 also obtained and executed portion E because of the dynamic change in flow (jump 1) included in portion B. This resulted in portions B and E being saved as B′ and E′, respectively, in optimized binary code 106-1 (with portion E′ associated with the dynamic change in flow being indicated by diagonal marks). Portions C-F were then executed and optimized, and saved as C′-F′, respectively, in optimized binary code 106-1. During the execution and optimization of portion G, DO 102 also obtained and executed portion J because of the dynamic change in flow (jump 2) included in portion G. This resulted in portions G and J being saved as G′ and J′, respectively, in optimized binary code 106-1 (with portion J′ being indicated by diagonal marks). Portions H and I were then executed and optimized, and saved as H′ and I′, respectively, in optimized binary code 106-1.

Once created, optimized binary code 106 is used for all future executions of the “blueprint” program. It should be kept in mind, however, that the data set used for the first execution of the program may not cover all the possibilities for this program. Thus, when optimized binary code 106 is used in a subsequent execution of the program, additional dynamic changes in flow that were not encountered during the first execution of the program may be encountered. By way of example, as shown in FIG. 3, when optimized binary code 106-1 is used for the Nth execution of the program, the data set for this execution triggers a dynamic change in flow (jump X) in portion F′, which takes the flow to portion K of binary code 104. As portion K is not included in optimized binary code 106-1, an exception occurs and DO 102 returns to binary code 104 to obtain the missing portion of the binary code, i.e., portion K, so that this portion of the binary code can be executed in conjunction with portion F′. After the missing portion of the binary code, e.g., portion K, is executed, this portion of the binary code is saved to the optimized binary code file for the program. Thus, as shown in FIG. 3, optimized binary code 106-N includes portion K′ (with portion K′ being indicated by diagonal marks).

DO 102 operates in a manner that ensures that the binary semantic of the optimized binary code remains unchanged, i.e., the values saved in each hardware register (including the PC register) are the same as if this code were executed by the “blueprint” program. All control transfer instructions in the optimized binary code are adjusted to execute the transfer to the corresponding address in the optimized binary code, rather than to the “blueprint” program. The data changes, e.g., save instructions, are executed at the address space of the “blueprint” program.

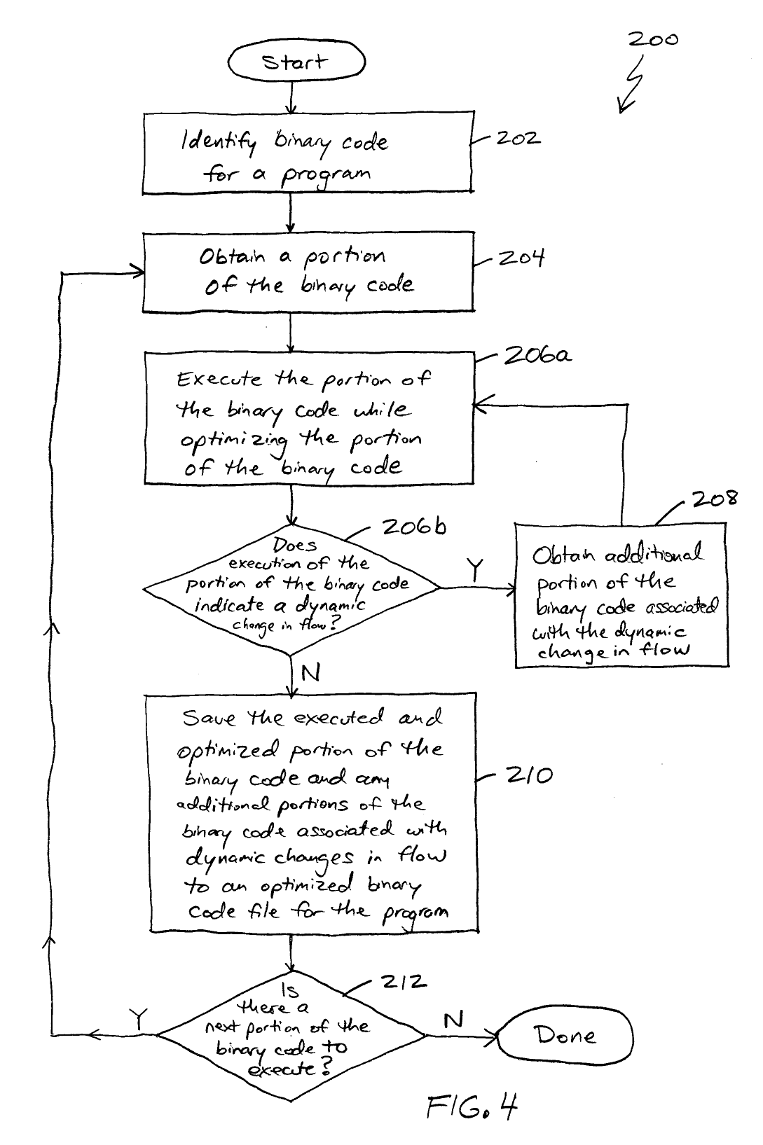

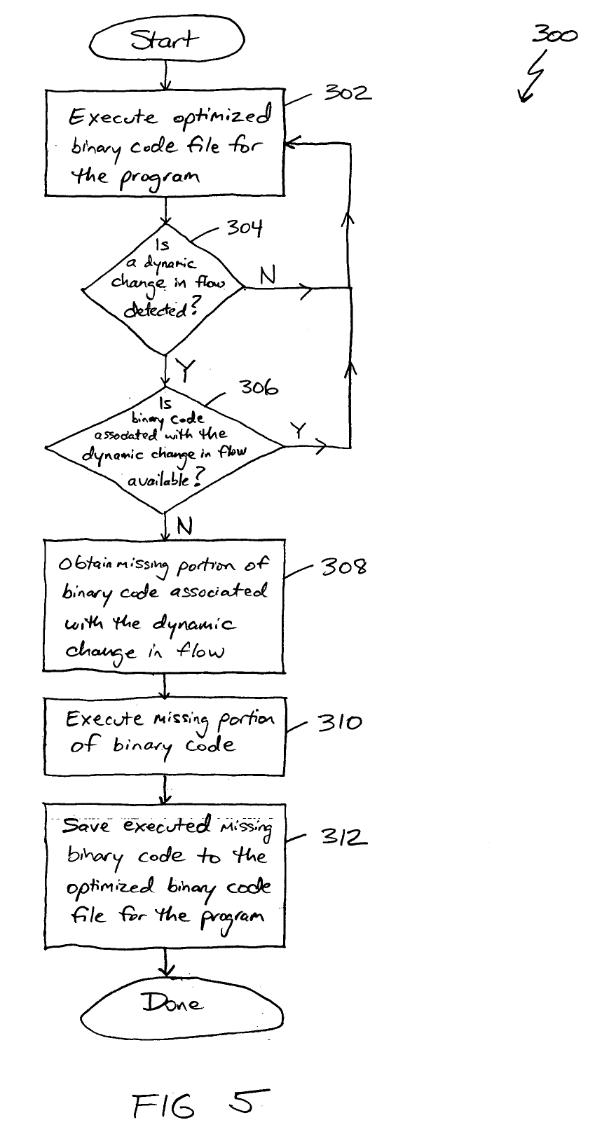

FIG. 4 is a flow chart diagram 200 illustrating the method operations performed in the dynamic recompilation of a program in accordance with one embodiment of the present invention. The method may be carried out, at least in part, by a dynamic optimizer, e.g., DO 102 described herein, or other appropriate software. The method begins in operation 202 in which the binary code for a program is identified. By way of example, the binary code for a program may be identified in a read operation. In operation 204, a portion of the binary code for the program is obtained. In one embodiment, the portion of the binary code that is obtained is a basic block. The method continues in operation 206a, which includes executing the portion of the binary code while optimizing the portion of the binary code. As described above, the optimization may be configured to modify the binary code for optimal performance when executed using a new hardware architecture, i.e., a hardware architecture different from that for which the program was originally compiled.

In decision operation 206b, it is determined whether the execution of the portion of the binary code indicates a dynamic change in flow. If a dynamic change in flow, e.g., a jump instruction, is indicated, then the method proceeds to operation 208. In operation 208, the additional portions of the binary code associated with the dynamic change in flow are obtained. Once the additional portions of the binary code associated with the dynamic change in flow have been obtained, the method returns to operation 206a so that the portion of the binary code can be executed and optimized in conjunction with the execution of the additional portions of the binary code associated with the dynamic change in flow. Thereafter, the method returns to decision operation 206b to determine whether the execution of the portion of the binary code and the additional portions of the binary code associated with the previously identified dynamic change in flow indicate any other dynamic changes in flow. If it is determined that the execution in question does not indicate any dynamic changes in flow, then the method proceeds to operation 210.

In operation 210, the executed and optimized portion of the binary code and any additional portions of the binary code associated with dynamic changes in flow are saved to an optimized binary code file for the program. The method then proceeds to decision operation 212 in which it is determined whether there is a next portion of the binary code to execute. If there is a next portion of the binary code to execute, then the method returns to operation 204 so that this next portion of the binary code can be obtained and executed in the manner described in connection with operations 204-210. If it is determined that there is no next portion of the binary code to execute, then the method is done. The next time the “blueprint” program is called, the optimized binary code file can be executed.

FIG. 5 is a flow chart diagram 300 illustrating the method operations performed in maintaining an optimized binary code file for a program in accordance with one embodiment of the present invention. The method may be carried out, at least in part, by a dynamic optimizer, e.g., DO 102 described herein, or other appropriate software. The method begins in operation 302 in which an optimized binary code file for a “blueprint” program is executed. In one embodiment, the optimized binary code file is obtained by the method shown in FIG. 4. In decision operation 304, it is determined whether a dynamic change in flow is detected during execution of the optimized binary code file. If a dynamic change in flow is not detected, then the method returns to operation 302 for continued execution of the optimized binary code file. If a dynamic change in flow is detected, then the method proceeds to decision operation 306. In decision operation 306, it is determined whether the binary code associated with the dynamic change in flow is available in the optimized binary code file. If the binary code associated with the dynamic change in flow is available in the optimized binary code file, then the method returns to operation 302 for continued execution of the optimized binary code file. If the binary code associated with the dynamic change in flow is missing, i.e., not available in the optimized binary code file, then the method proceeds to operation 308.

In operation 308, the missing binary code associated with the dynamic change in flow is obtained from the binary code for the “blueprint” program. In operation 310, the missing binary code associated with the dynamic change in flow is executed. In operation 312, the executed missing binary code associated with the dynamic change in flow is saved to the optimized binary code file for the “blueprint” program. Once the executed missing binary code has been saved, the method is done. Updating the optimized binary code file in this manner ensures that all dynamic changes in flow are properly executed and thereby enables a complete version of the optimized binary code file for the “blueprint” program to be created.

Those skilled in the art will recognize that the order in which the method operations are performed may be varied from that described herein, e.g., by rearranging the order in which the method operations are performed or by performing some of the method operations in parallel. Further, while the present invention has been described in the general context of an application program that is executed on an operating system in conjunction with a test system, it should be appreciated that the invention may be implemented with other routines, programs, components, data structures, etc., which perform particular tasks or implement particular abstract data types. In addition, the present invention may be practiced with other computer system configurations including hand-held devices, microprocessor systems, microprocessor-based or programmable consumer electronics, minicomputers, mainframe computers, and the like.

With the embodiments described herein in mind, it should be understood that the present invention may employ various computer-implemented operations involving data stored in computer systems. These operations are those requiring physical manipulation of physical quantities. These quantities usually, but not necessarily, take the form of electrical or magnetic signals capable of being stored, transferred, combined, compared, and otherwise manipulated. Further, the manipulations performed are often referred to using terms such as producing, identifying, determining, or comparing.

Any of the operations described herein that form part of the present invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The present invention also can be embodied as computer readable code on a computer readable medium. The computer readable medium may be any data storage device that can store data which can be thereafter be read by a computer system. Examples of the computer readable medium include hard drives, network attached storage (NAS), read-only memory, random access memory, CD-ROMs, CD-Rs, CD-RWs, magnetic tapes, and other optical and non-optical data storage devices. The computer readable medium also can be distributed over network coupled computer systems so that the computer readable code is stored and executed in a distributed fashion.

In summary, the present invention provides a method for dynamic recompilation of a program. The invention has been described herein in terms of several exemplary embodiments. Other embodiments of the invention will be apparent to those skilled in the art from consideration of the specification and practice of the invention. The embodiments and preferred features described above should be considered exemplary, with the invention being defined by the appended claims and equivalents thereof.

1. A method for dynamic recompilation of a program, comprising:
identifying binary code for a program;
obtaining a portion of the binary code;
executing the portion of the binary code while optimizing the portion of the binary code, the executing identifying dynamic changes in flow to enable additional portions of the binary code to be obtained and executed; and
saving the executed and optimized portion of the binary code and any additional portions of the binary code to an optimized binary code file for the program.

2. The method of claim 1, further comprising:
continuing obtaining and executing portions of the binary code until all portions of the binary code have been saved to the optimized binary code file for the program.

3. The method of claim 2, further comprising:
executing the optimized binary code file for the program;
detecting a missing additional portion associated with a dynamic change in flow detected during execution of a portion of the optimized binary code file for the program;
obtaining the missing additional portion from the binary code for the program;
executing the missing additional portion; and
saving the executed missing additional portion to the optimized binary code file for the program.

4. The method of claim 1, wherein the dynamic changes in flow include a jump instruction.

5. The method of claim 1, wherein the optimizing is configured to optimize the portion of the binary code for a new hardware architecture.

6. A method for dynamic recompilation of a program, comprising:
a) identifying binary code for a program;
b) obtaining a portion of the binary code;
c) executing the portion of the binary code while optimizing the portion of the binary code, the executing identifying dynamic changes in flow to enable additional portions of the binary code to be obtained and executed;
d) saving the executed and optimized portion of the binary code and any additional portions of the binary code to an optimized binary code file for the program; and
e) repeating operations b), c), and d) until all portions of the binary code have been saved to the optimized binary code file for the program.

7. The method of claim 6, further comprising:
executing the optimized binary code file for the program;
detecting a missing additional portion associated with a dynamic change in flow detected during execution of a portion of the optimized binary code file for the program;
obtaining the missing additional portion from the binary code for the program;
executing the missing additional portion; and
saving the executed missing additional portion to the optimized binary code file for the program.

8. The method of claim 7, wherein the dynamic changes in flow include a jump instruction.

9. The method of claim 6, wherein the optimizing is configured to optimize the portion of the binary code for a new hardware architecture.

10. Computer readable media containing program instructions for dynamic recompilation of a program, the computer readable media comprising:
program instructions for identifying binary code for a program;
program instructions for obtaining a portion of the binary code;
program instructions for executing the portion of the binary code while optimizing the portion of the binary code, the executing identifying dynamic changes in flow to enable additional portions of the binary code to be obtained and executed; and
program instructions for saving the executed and optimized portion of the binary code and any additional portions of the binary code to an optimized binary code file for the program.

11. The computer readable media of claim 10, further comprising:
program instructions for continuing obtaining and executing portions of the binary code until all portions of the binary code have been saved to the optimized binary code file for the program.

12. The computer readable media of claim 11, further comprising:
program instructions for executing the optimized binary code file for the program;
program instructions for detecting a missing additional portion associated with a dynamic change in flow detected during execution of a portion of the optimized binary code file for the program;
program instructions for obtaining the missing additional portion from the binary code for the program;
program instructions for executing the missing additional portion; and
program instructions for saving the executed missing additional portion to the optimized binary code file for the program.

13. The computer readable media of claim 10, wherein the dynamic changes in flow include a jump instruction.

14. The method of claim 10, wherein the optimizing is configured to optimize the portion of the binary code for a new hardware architecture.

15. Computer readable media containing program instructions for dynamic recompilation of a program, the computer readable media comprising:
a) program instructions for identifying binary code for a program;
b) program instructions for obtaining a portion of the binary code;
c) program instructions for executing the portion of the binary code while optimizing the portion of the binary code, the executing identifying dynamic changes in flow to enable additional portions of the binary code to be obtained and executed;
d) program instructions for saving the executed and optimized portion of the binary code and any additional portions of the binary code to an optimized binary code file for the program; and
e) program instructions for repeating program instructions b), c), and d) until all portions of the binary code have been saved to the optimized binary code file for the program.

16. The computer readable media of claim 15, further comprising:
program instructions for executing the optimized binary code file for the program;
program instructions for detecting a missing additional portion associated with a dynamic change in flow detected during execution of a portion of the optimized binary code file for the program;
program instructions for obtaining the missing additional portion from the binary code for the program;
program instructions for executing the missing additional portion; and
program instructions for saving the executed missing additional portion to the optimized binary code file for the program.

17. The computer readable media of claim 15, wherein the dynamic changes in flow include a jump instruction.

18. The method of claim 15, wherein the optimizing is configured to optimize the portion of the binary code for a new hardware architecture.
